(19) United States
(12) Patent Application Publication
(10) Pub. No.: US 2018/0306163 A1
(43) Pub. Date: Oct. 25, 2018

(54) SYSTEM AND METHOD FOR DETERMINING HEALTH STATE OF A SPARK PLUG

(71) Applicant: Caterpillar Inc., Peoria, IL (US)

(72) Inventors: Morteza Rezaei, Peoria, IL (US); William Eugene Hoban, JR., Dunlap, IL (US)

(73) Assignee: Caterpillar Inc., Peoria, IL (US)

(21) Appl. No.: 15/493,502

(22) Filed: Apr. 21, 2017

(51) Int. Cl. F02P 17/00; F02P 5/145; F02P 9/00; H01T 13/60

(52) U.S. Cl. CPC F02P 17/00; H01T 13/60; F02P 9/002; F02P 5/145

(57) ABSTRACT

A system and method for determining a health state of a spark plug of an ignition system is provided. The system includes a detection module configured to measure a time duration associated with a current flowing through a primary coil of the ignition system. The detection module is configured to generate a signal indicative of the time duration. The controller, coupled to the detection module, is configured to receive the signal and determine a secondary voltage across a secondary coil of the ignition system based on the received signal. The controller is further configured to determine the health state of the spark plug based on the secondary voltage. The controller is further configured to control at least one of a primary voltage supplied to the primary coil, the spark duration and the timing of firing the spark plug based on the health state of the spark plug.

### TECHNICAL FIELD

The present disclosure relates to spark plugs used in ignition systems of engines. More particularly, the present disclosure relates to system and method for determining health state of a spark plug.

### BACKGROUND

Many engines, including gasoline engines, gaseous-fuel engines, and dual-fuel engines, include an ignition system for igniting an air-fuel mixture to produce heat, which may be used to produce mechanical power. Some ignition systems include a spark plug that produces a spark to initiate combustion of the air-fuel mixture. Ignition systems typically include a primary coil and a secondary coil coupled to the primary coil. The spark plug is connected across the secondary coil, and a current through the primary coil induces a high voltage across the secondary coil that establishes an arc across the spark gap of the spark plug. In some engines, a monitoring system measures various parameters of the ignition system as the engine operates. An electronic control unit (ECU) and/or a machine operator may use information output by the monitoring system to monitor engine operation and/or to determine when maintenance is required (e.g., a spark plug needs to be replaced). For example, the ECU may determine secondary voltage (i.e., voltage across the secondary coil of the ignition system), which may be an indicator of the condition of the spark plug.

In previous monitoring systems, an ECU may estimate secondary voltage based on measurement of parameters using one or more sensors coupled with the ignition system. For example, a sensor or a voltage divider may be provided on the secondary side of the ignition system to measure the secondary voltage. However, this requires adding a wiring harness to couple the sensor and associated circuitry with the ignition system. While these arrangements may give some indication of secondary voltage, the overall setup becomes complex due to addition of sensor circuitry and associated wiring harness.

The present disclosure is directed to overcoming one or more of the problems set forth above and/or other problems of the prior art. The present invention is directed to solving one or more of the problems as set forth above.

### SUMMARY

In an aspect of the present disclosure, a method for determining a health state of a spark plug of an ignition system is provided. The method includes supplying a primary voltage across a primary coil of the ignition system. The method includes measuring, by a detection module, a time duration associated with a current flowing through the primary coil of the ignition system after the primary voltage has been supplied across the primary coil. The method includes generating a signal indicative of the time duration by the detection module. The method includes receiving, by a controller, the signal indicative of the time duration. The method further includes determining, by the controller, a secondary voltage across a secondary coil of the ignition system based on the received signal. Further, the method includes determining, by the controller, the health state of the spark plug based on the secondary voltage. The method further includes controlling, by the controller, at least one of the primary voltage, a spark duration and a timing of firing the spark plug based on the health state of the spark plug.

In another aspect of the present disclosure, a system for determining the health state of the spark plug is provided. The system comprises an ignition system including a primary coil, a secondary coil, and the spark plug. The system comprises a power source coupled to the ignition system, the power source configured to supply a primary voltage across the primary coil of the ignition system. The system further comprises a detection module coupled to the ignition system. The detection module is configured to measure a time duration associated with a current flowing through the primary coil of the ignition system, and to generate a signal indicative of the time duration. The system further comprises a controller communicably coupled to the detection module. The controller is configured to receive the signal indicative of the time duration from the detection module. The controller is further configured to determine a secondary voltage across the secondary coil of the ignition system based on the received signal. The controller is configured to determine the health state of the spark plug based on the secondary voltage. The controller is further configured to control at least one of the primary voltage, a spark duration and a timing of firing the spark plug based on the health state of the spark plug.

In yet another aspect of the present disclosure, an engine is provided. The engine comprises a combustion chamber and an ignition system including a primary coil, a secondary coil, and a spark plug wherein the spark plug is configured to ignite a fuel mixture by generating a spark within the combustion chamber. The engine further comprises a power source coupled to the ignition system, the power source configured to supply a primary voltage across the primary coil of the ignition system. The engine comprises a detection module coupled to the ignition system, the detection module configured to measure a time duration associated with a current flowing through the primary coil after the primary voltage has been supplied across the primary coil. The detection module is configured to generate a signal indicative of the time duration. The engine further comprises a controller communicably coupled to the detection module. The controller is configured to receive the signal indicative of the time duration. The controller is further configured to determine a secondary voltage across the secondary coil based on the received signal. The controller is configured to determine a health state of the spark plug based on the secondary voltage. The controller is further configured to control at least one of the primary voltage, a spark duration and a timing of firing the spark plug based on the health state of the spark plug.

### BRIEF DESCRIPTION OF DRAWINGS

FIG. 1 is a schematic illustration of an exemplary disclosed engine;

FIG. 2 is a schematic illustration of an exemplary ignition system, in accordance with the concepts of the present disclosure;

FIG. 3 is an example waveform of the current flowing through the primary coil during an ignition cycle, in accordance with the concepts of the present disclosure;

FIG. 4 illustrates example waveforms of the current flowing through the primary coil for different operating conditions, in accordance with the concepts of the present disclosure;

FIG. 5 illustrates example waveforms of the secondary voltage for different operating conditions, in accordance with the concepts of the present disclosure;

FIG. 6 is an example representation of the secondary voltages and time durations of breakdown phase for the waveforms shown in FIG. 5; and

FIG. 7 is a flowchart of a method for determining the health state of the spark plug, in accordance with the concepts of the present disclosure.

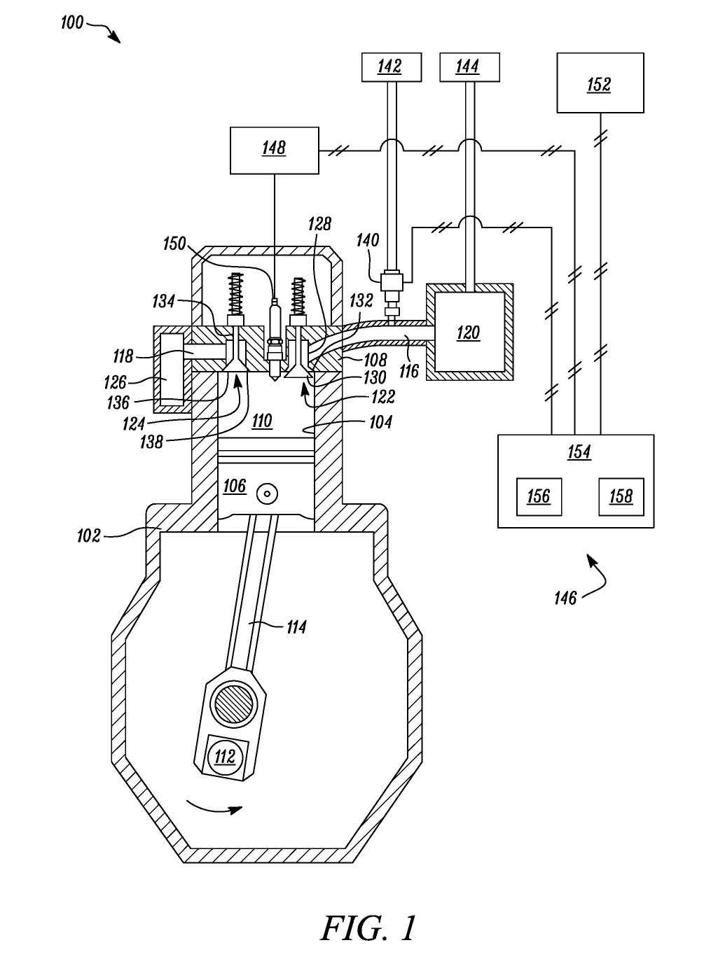

### DETAILED DESCRIPTION

Wherever possible, the same reference numbers will be used throughout the drawings to refer to same or like parts. FIG. 1 illustrates an exemplary combustion engine 100. For the purposes of this disclosure, the engine 100 will be described as a four-stroke gaseous-fueled engine, for example a natural gas engine. One skilled in the art will recognize, however, that the engine 100 may be any other type of combustion engine such as, for example, a gasoline or a dual-fuel engine. The engine 100 includes an engine block 102 that at least partially defines one or more cylinders 104 (only one shown in FIG. 1). A piston 106 is slidably disposed within each cylinder 104 to reciprocate between a top-dead-center (TDC) position and a bottom-dead-center (BDC) position, and a cylinder head 108 is associated with each cylinder 104. The cylinder 104, the piston 106, and the cylinder head 108 together define a combustion chamber 110. It is contemplated that the engine 100 includes any number of combustion chambers 110 and that combustion chambers 110 may be disposed in an “in-line” configuration, a “V” configuration, or in any other suitable configuration.

The engine 100 also includes a crankshaft 112 that is rotatably disposed within the engine block 102. A connecting rod 114 connects each piston 106 to the crankshaft 112 so that a sliding motion of the piston 106 between the TDC and BDC positions within each respective cylinder 104 results in a rotation of the crankshaft 112. Similarly, a rotation of the crankshaft 112 may result in a sliding motion of the piston 106 between the TDC and BDC positions. In a four-stroke engine, the piston 106 may reciprocate between the TDC and BDC positions through an intake stroke, a compression stroke, a combustion or power stroke, and an exhaust stroke. It is also contemplated that the engine 100 may alternatively be a two-stroke engine, wherein a complete cycle includes a compression/exhaust stroke (BDC to TDC) and a power/exhaust/intake stroke (TDC to BDC).

The cylinder head 108 defines an intake passageway 116 and an exhaust passageway 118. The intake passageway 116 directs compressed air or an air and fuel mixture (also referred as fuel mixture) from an intake manifold 120, through an intake opening 122, and into the combustion chamber 110. The exhaust passageway 118 similarly directs exhaust gases from the combustion chamber 110, through an exhaust opening 124, and into an exhaust manifold 126.

An intake valve 128 having a valve element 130 is disposed within the intake opening 122 and configured to selectively engage a seat 132. The valve element 130 may be movable between a first position, at which the valve element 130 engages the seat 132 to inhibit a flow of fluid relative to the intake opening 122, and a second position, at which the valve element 130 is removed from the seat 132 to allow the flow of fluid.

An exhaust valve 134 having a valve element 136 is similarly disposed within exhaust opening 124 and configured to selectively engage a seat 138. The valve element 136 may be movable between a first position, at which the valve element 136 engages the seat 138 to inhibit a flow of fluid relative to the exhaust opening 124, and a second position, at which the valve element 136 is removed from the seat 138 to allow the flow of fluid.

A series of valve actuation assemblies (not shown) may be operatively associated with the engine 100 to move valve elements 130 and 136 between the first and second positions. It should be noted that each cylinder head 108 may include multiple intake openings 122 and multiple exhaust openings 124. Each such opening would be associated with either the intake valve element 130 or the exhaust valve element 136. The engine 100 may include a valve actuation assembly for each cylinder head 108 that is configured to actuate all of the intake valves 128 or all of the exhaust valves 134 of the cylinder head 108. It is also contemplated that a single valve actuation assembly could actuate the intake valves 128 or the exhaust valves 134 associated with multiple cylinder heads 108, if desired. The valve actuation assemblies may embody, for example, a cam/push-rod/rocker arm arrangement, a solenoid actuator, a hydraulic actuator, or any other means for actuating known in the art.

A fuel injection device 140 is associated with the engine 100 to direct pressurized fuel into the combustion chamber 110. The fuel injection device 140 may embody, for example, an electronic valve situated in communication with the intake passageway 116. The fuel injection device 140 is coupled to a fuel supply 142. It is contemplated that the fuel injection device 140 could alternatively embody a hydraulically, mechanically, or pneumatically actuated injection device that selectively pressurizes and/or allows pressurized fuel to pass into the combustion chamber 110 via the intake passageway 116 or in another manner (i.e., directly). The intake manifold 120 is coupled to an air supply 144. The fuel may include a compressed gaseous fuel such as, for example, natural gas, propane, bio-gas, landfill gas, or hydrogen. It is also contemplated that the fuel may be liquefied, for example, gasoline, diesel, methanol, ethanol, or any other liquid fuel, and that an onboard pump (not shown) may be required to pressurize the fuel.

The amount of fuel allowed into the intake passageway 116 by the fuel injection device 140 may be associated with a ratio of fuel-to-air introduced into the combustion chamber 110. Specifically, if it is desired to introduce a lean mixture of fuel and air (i.e., fuel mixture having a relatively low amount of fuel compared to the amount of air) into the combustion chamber 110, the fuel injection device 140 may remain in an injecting position for a shorter period of time (or otherwise be controlled to inject less fuel per given cycle) than if a rich mixture of fuel and air (i.e., fuel mixture having a relatively large amount of fuel compared to the amount of air) is desired. Likewise, if a rich mixture of fuel and air is desired, the fuel injection device 140 may remain in the injecting position for a longer period of time (or otherwise be controlled to inject more fuel per given cycle) than if a lean mixture is desired.

An ignition system 146 is associated with the engine 100 to help regulate the combustion of the fuel mixture within the combustion chamber 110 during a series of ignition sequences. In an exemplary embodiment, the ignition system 146 may be a capacitive discharge ignition system, although other systems are possible. The ignition system 146 may include any known ignition components, such as an ignition coil 148, a spark plug 150, one or more auxiliary injectors (not shown), a power source 152, and an electronic control unit (ECU) 154. The ECU 154 may be configured to regulate operation of such ignition system components based on a stored control strategy and/or in response to input received from other components of the engine 100.

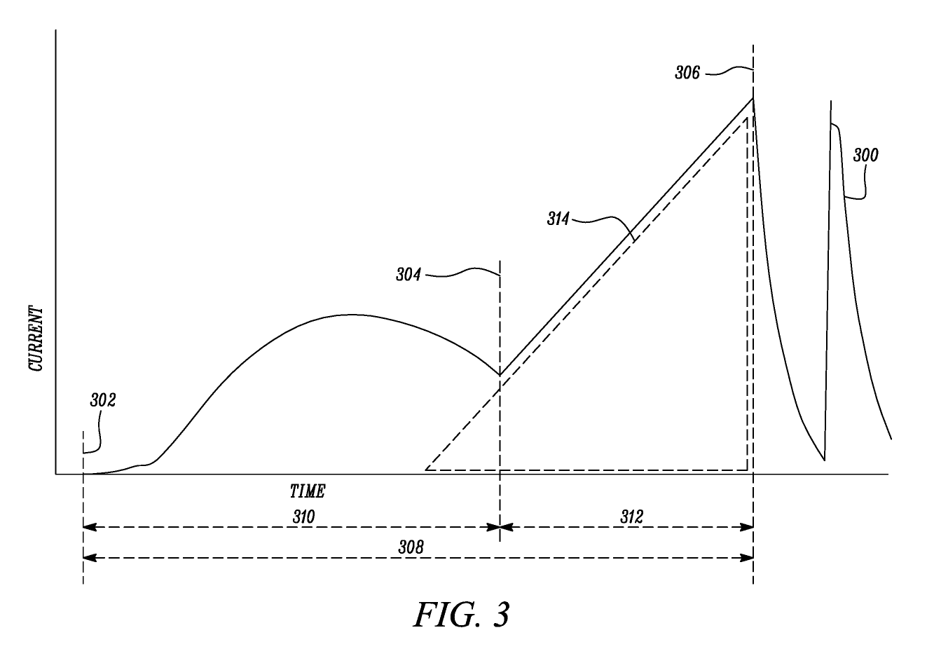

The ignition coil 148 may be operatively connected, electrically coupled, in communication, and/or otherwise associated with the ECU 154, the spark plug 150, and/or the power source 152. The ignition coil 148 may be a separate component of the ignition system 146 or, in additional exemplary embodiments, the ignition coil 148 may be a component of the spark plug 150 or other electrical devices included in the ignition system 146. The ignition coil 148 may comprise an inductor, a capacitor, and/or other like electrical devices configured to store electrical energy until such energy is controllably released. Such energy storage and/or discharge characteristics of the ignition coil may result in the waveforms illustrated in FIGS. 3-5. In some embodiments, the ignition coil 148 includes a primary coil (not shown) and a secondary coil (not shown) such that the primary coil is electrically coupled to the ECU 154 and the secondary coil is electrically coupled to the spark plug 150.

The spark plug 150 facilitates ignition of the fuel mixture (comprising fuel and air) within the combustion chamber 110 during each ignition sequence. Specifically, to initiate combustion of the fuel mixture during a startup event or during operation of the engine 100, the spark plug 150 generates a spark that locally heats the fuel mixture, thereby creating a flame that propagates throughout the combustion chamber 110. The spark plug 150 may produce a spark, for example, after a flow of an electrical current is directed to the ignition coil 148 at a desired voltage. As the combustion process progresses, the temperature within the combustion chamber 110 may continue to rise to a level that supports efficient auto-ignition of the fuel mixture. It should be understood that the spark plug 150 may alternatively be another type of igniter known in the art.

The power source 152 is operably connected to the ECU 154 and configured to supply energy to one or more components of the ignition system 146 and/or other engine components discussed herein. The power source 152, in some embodiments, may be provided inside the ECU 154. In an exemplary embodiment, the power source 152 may be a constant voltage, direct current source such as a battery or other similar device. In some embodiments, the power source 152 may embody the battery of the vehicle to which the engine 100 is connected. In alternative exemplary embodiments, however, the power source 152 may be separate from the vehicle battery and may be, for example, dedicated to supplying power to the ignition system 146. In still further exemplary embodiments, the power source 152 may be an alternating current source of electrical energy. The power source 152 may be configured to direct any desired voltage to the components of the ignition system 146 to facilitate operation thereof, and such voltage may be increased and/or decreased by one or more converters, stepper circuits, amplification circuits, and/or other like electrical components. In some embodiments, the voltage supplied by the power source 152 may be controlled by the ECU 154.

The ECU 154 may embody a single or multiple microprocessors, field programmable gate arrays (FPGAs), digital signal processors (DSPs), etc., that include a means for controlling an operation of the engine 100 and/or individual engine components. For example, the ECU 154 may be configured to control the ignition system 146 and/or the power source 152, based upon a control program stored in a memory associated with the ECU 154. Numerous commercially available microprocessors can be configured to perform the functions of the ECU 154. It should be appreciated that the ECU 154 could readily embody a general engine microprocessor capable of controlling numerous system functions and modes of operation. Various other known circuits may be associated with the ECU 154, including power source circuitry, signal-conditioning circuitry, actuator driver circuitry powering solenoids, motors, or piezo actuators), communication circuitry, timer circuitry, and other appropriate circuitry.

The ECU 154 includes a detection module 156 configured to detect, measure, and/or monitor one or more parameters associated with the ignition system 146. The detection module 156 may include one or more detection, measurement, monitoring, and/or processing components configured to detect, measure, and/or monitor one or more parameters associated with the ignition system 146. The detection module 156 is electrically coupled to various components of the ignition system 146. For example, the detection module 156 may be configured to measure voltage and/or current associated with the ignition coil 148 and/or one or more circuits and or electrical connections between the ignition coil 148 and the power source 152. The detection module 156 is electronically connected to other components of the ECU 154 such that the various components of the ECU 154 may send and receive signals to/from the detection module 156.

The detection module 156 is configured to measure a time duration associated with a current flowing through the ignition coil 148. The detection module 156 is configured to process a current signal corresponding to the current flowing through the ignition coil 148. In some embodiments, the time duration may be a rise time of the current flowing through the ignition coil 148. The rise time may be calculated as the difference between the times at which current is at 0% and 100% of a maximum value. Additionally, or alternatively, the time duration may be a spark time (i.e., a time difference between providing power to the ignition coil 148 and detecting a spark generated by the spark plug 150). The detection module 156 may be configured to measure the spark time by processing the current signal corresponding to the current flowing through the ignition coil 148. The detection module 156 may be configured to generate a signal indicative of the time duration. The detection module 156 provides the signal to a controller 158 provided within the ECU 154. In some embodiments, the detection module 156 may utilize the circuitry and/or components of the ECU 154 for processing of the signal. Alternatively, the detection module 156 may have circuitry and/or components for processing of the signal. In some embodiments, the detection module 156 may be implemented using a combination of both the hardware and the software.

The controller 158 receives the signal indicative of the time duration associated with the current from the detection module 156. The controller 158 is configured to determine a health state of the spark plug 150 based on the received signal. The controller 158 may compute one or more intermediate parameters while determining the health state of the spark plug 150 using the received signal. For example, the controller 158 may determine a voltage across the ignition coil 148 for determining the health state of the spark plug 150. As another example, the controller 158 may determine a predetermined time duration from the measured time duration when the measured time duration is indicative of the rise time. The predetermined time duration may be constant for different operating conditions of the spark plug 150. The controller 158 may embody a single or multiple microprocessors, field programmable gate arrays (FPGAs), digital signal processors (DSPs), etc., that include a means for controlling an operation of the engine 100 and/or individual engine components. Various other known circuits may be associated with the controller 158, including power source circuitry, signal-conditioning circuitry, actuator driver circuitry powering solenoids, motors, or piezo actuators), communication circuitry, and timer circuitry.

The health state may include one or more parameters indicating the condition of the spark plug 150. For example, the health state (or the one or more parameters) may indicate an age of the spark plug 150, a degree/measure of degradation of the spark plug 150, a need for replacement of the spark plug, a remaining life of the spark plug 150, and/or the like. In case of multiple cylinders 104, determining the health state may include determining a remaining life of the spark plug per cylinder. A look-up table comprising the mapping of the one or more parameters with the corresponding values of the age of the spark plug 150 may be used to compute the age of the spark plug 150.

The health state may be used to generate customer reports, recommendations and/or notifications indicating the condition of the spark plug 150 for customers, service personnel, condition monitoring analyst, and/or the like. In some embodiments, the ECU 154 may generate a notification corresponding to the health state of the spark plug 150. For example, the ECU 154 may be configured to indicate, using an indicator (not shown), that the spark plug 150 needs to be replaced. The notification may be displayed on a display panel (not shown) of the ECU 154 or other displays associated with the engine 100. In various embodiments, the notification corresponding to the health state is transmitted to a remote display. The health state may be used to schedule diagnostics and/or maintenance of the spark plug 150. For example, a service personnel may be informed to schedule diagnostics and/or maintenance of the spark plug 150 when the remaining life of the spark plug 150 is less than a threshold amount of time (e.g., 2 months). The ECU 154 may be configured to compensate the health state of the spark plug 150 by automatically taking one or more corrective actions. For example, the ECU 154 may be configured to increase voltage supplied to the ignition coil 148 to compensate for the degradation of the spark plug 150. As another example, the ECU 154 may be configured to control a spark duration (i.e., time between start of a spark and end of the spark) of the spark plug 150 based on the health state of the spark plug 150. As another example, the ECU 154 may be configured to control a timing of firing the spark plug 150 to compensate for the degradation of the spark plug 150. The health state may also be used to optimize the usage of the engine 100. For example, depending on the remaining life of the spark plug 150, the engine 100 may be controlled to operate at a reduced capacity.

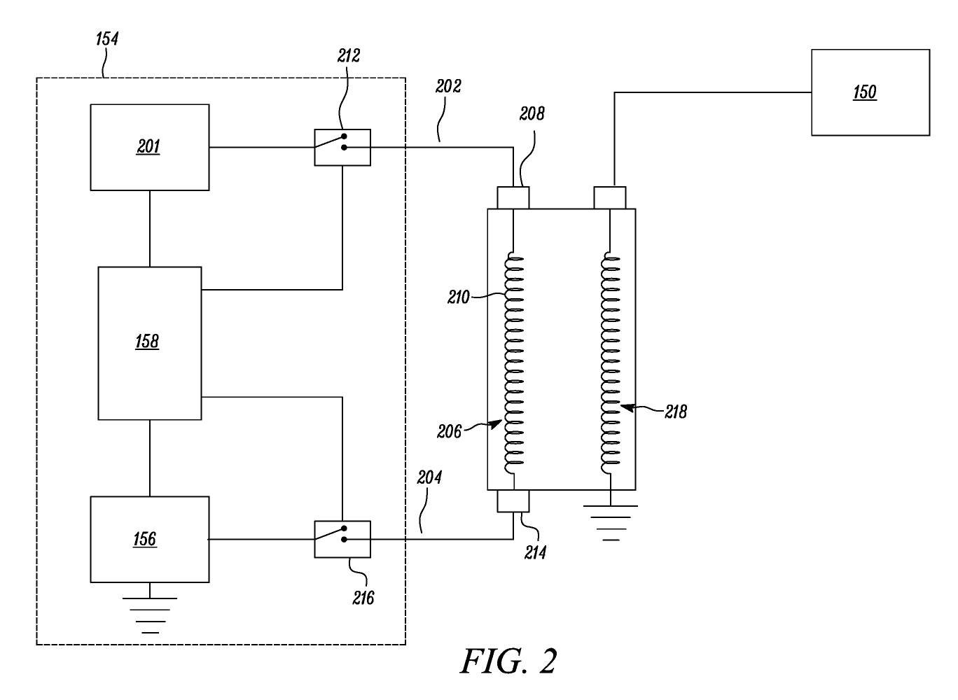

FIG. 2 illustrates the ECU 154 that can be used in conjunction with the various components of the ignition system 146 in accordance with an example embodiment of the invention. The ECU 154 includes a power supply 201 to supply primary voltage to the ignition coil 148. The power supply 201 may include or be connected to a converter configured to convert the electricity into a form suitable for the ignition coil 148. In some embodiments, output of the power supply 201 may be controlled by one or more components of the ECU 154. In an exemplary embodiment, the power supply 201 may not be a part of the ECU 154 and can be located outside the ECU 154.

The ignition coil 148 includes a high side 202 and a low side 204. The high side 202 leads to a primary coil 206 of the ignition coil 148, such as through a high side pin 208. The primary coil 206 includes primary windings 210 connected between the high side 202 and the low side 204. The high side 202 also includes a high side switch 212 (also referred to as high side driver 212) connected between the power supply 201 and the ignition coil 148. The high side driver 212, which is controlled by the controller 158, may be an ignition switch configured to open and close to selectively complete a circuit between the power supply 201 and the ignition coil 148. In addition, during an ignition cycle, the high side switch 212 may open and close to modulate current in the ignition coil 148 between an upper threshold and a lower threshold.

As shown in FIG. 2, the primary coil 206 leads to the low side 204 of the ignition coil 148, such as through a low side pin 214. The low side 204 includes a low side switch 216 (also referred to as low side driver 216) and the detection module 156. The low side driver 216, which is controlled by the controller 158, may be a switch configured to open and close to selectively allow current to flow through the primary coil 206 and, thereby, building a voltage across a secondary coil 218. The secondary coil 218 directs the high voltage to the spark plug 150 for generation of a spark. The detection module 156 is configured to determine a parameter associated with the primary current flowing through the primary coil 206. Further, the detection module 156 provides a signal indicative of the parameter to the controller 158. In various embodiments, the parameter may be a time-related parameter.

The detection module 156 is configured to determine a time duration associated with the primary current flowing through the primary coil 206. In some embodiments, the time duration may be a rise time of the primary current. The rise time may be calculated as the difference between the times at which the current is at 0% and 100% of a maximum value. In an exemplary embodiment, the detection module 156 may comprise a resistor (not shown) to measure the primary current flowing through the primary coil 206. One skilled in the art will recognize that the detection module 156 may employ various known methods of measuring the current.

Additionally, or alternatively, the time duration may be a spark time i.e. time difference between closing of the high side switch 212 and the low side switch 216 and generation of a spark due to a voltage difference across electrodes of the spark plug 150. The detection module 156 may be configured to determine spark time using the primary current. The detection module 156 may be configured to detect the occurrence of the spark using techniques known to a person of ordinary skill in the art. The controller 158 generates the signal indicative of the time duration.

The controller 158 receives the signal indicative of the time duration from the detection module 156. The controller 158 is configured to determine a secondary voltage i.e. voltage across the secondary coil 218 of the ignition system 146 based on the received signal. The secondary voltage is an indication of the health state of the spark plug 150. The controller 158 is configured to determine the health state of the spark plug 150 based on the secondary voltage. An increment in the secondary voltage may indicate an increment in the age of the spark plug 150. For example, an increase in the secondary voltage may be proportional to an increase in the age of the spark plug 150. Further, for two different spark plugs having the same age, the secondary voltage may be different. In some embodiments, the controller 158 generates a notification corresponding to the health state of the spark plug 150. For example, the controller 158 may be configured to indicate, using an indicator (not shown), that the spark plug 150 needs to be replaced. The notification may be displayed on a display panel (not shown) of the ECU 154 or other displays associated with the engine 100. The notification corresponding to the health state may also be transmitted to a remote display.

The controller 158 may be configured to compensate for the degradation of the spark plug 150. In some embodiments, the controller 158 is configured to control the primary voltage supplied to the primary coil 206 depending on the health state of the spark plug 150. The controller 158 may regulate the power supply 201 based on the health state. The controller 158 may increase or decrease the voltage provided to the high side driver 212 to compensate for the degradation of the spark plug 150. One or more mathematical equations, look-up tables, and algorithms may be used by the controller 158 to compute the required amount of increase or decrease in the voltage. In an exemplary embodiment, the voltage provided to the high side driver 212 is doubled by the controller 158 when the remaining life of the spark is reduced by half. Additionally, or alternatively, the controller 158 may be configured to control the spark duration of the spark plug 150 based on the health state of the spark plug 150. In some embodiments, the controller 158 may be configured to control a timing of firing the spark plug 150 to compensate for the degradation of the spark plug 150. For example, the controller 158 may be configured to control the timing of firing such that the spark plug 150 is fired early to compensate for the degradation of the spark plug 150.

FIG. 3 illustrates an example waveform 300 of the current flowing through the primary coil during an ignition cycle. The high side switch 212 and the low side switch 216 are closed at a time 302, which may cause a voltage difference across electrodes of the spark plug 150, resulting in a spark at a time 304. As depicted in FIG. 3, the time 302 and a time 306 represent the times at which the current is at 0% and 100% of the maximum value, respectively. The detection module 156 may be configured to compute a rise time 308 of the primary current as the time difference between the time 302 and the time 306.

The operation of the spark plug 150 may be divided into a breakdown phase and a post breakdown phase. A time 310 shows time duration of the breakdown phase and is referred to as breakdown time. During the breakdown phase, the current follows resonant path of the ignition coil 148 and the spark plug 150. End of the breakdown phase results in creation of an ionic channel in spark gap. A time 312 shows time duration of the post breakdown phase. During the post breakdown phase, the ionic channel is already created and the shape of the waveform 300 is independent of the characteristics of the primary coil 206 and the spark plug 150. During the post breakdown phase, the waveform 300 may be considered equivalent to a side of the triangle 314 as shown in FIG. 3. Thus, for different operating conditions at secondary side or different operating durations, slope of the waveform 300 remains same during the post breakdown phase.

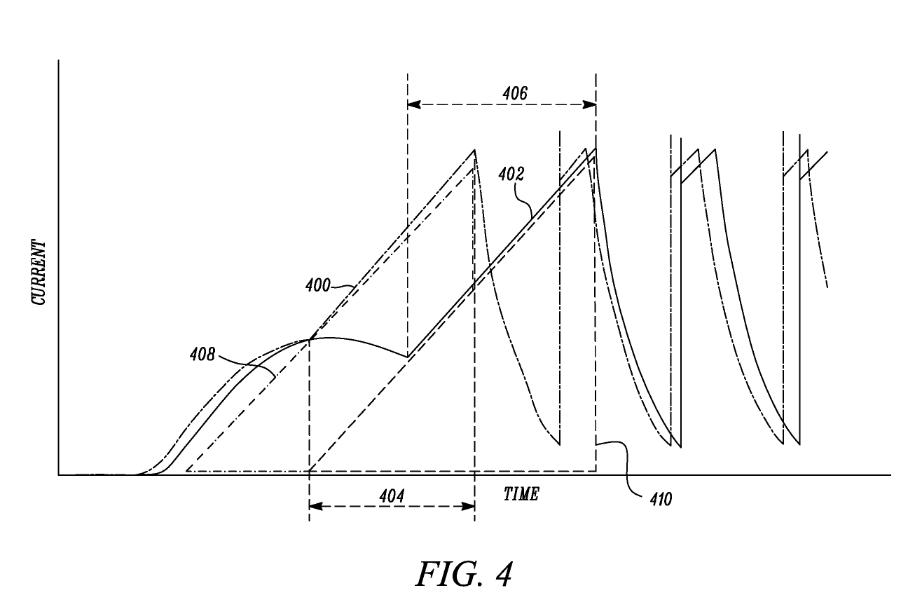

FIG. 4 illustrates example waveforms 400 and 402 of the current flowing through the primary coil 206 for different operating durations and/or different secondary side conditions. As shown in FIG. 4, slopes of the waveforms 400 and 402 during the post breakdown phase are identical. Thus, a time 404 of post breakdown phase of the waveform 400 is equal to a time 406 of post breakdown phase of the waveform 402. This constant value of time is hereinafter referred to as a post breakdown constant. During the post breakdown phase, the waveform 400 may be considered equivalent to a side of the triangle 408. Similarly, the waveform 402 may be considered equivalent to a side of the triangle 410. Thus, for different operating conditions at secondary side and/or different operating durations, the post breakdown constant remains same. This property of the primary current waveforms 400, 402 may be used to compute the corresponding secondary voltage.

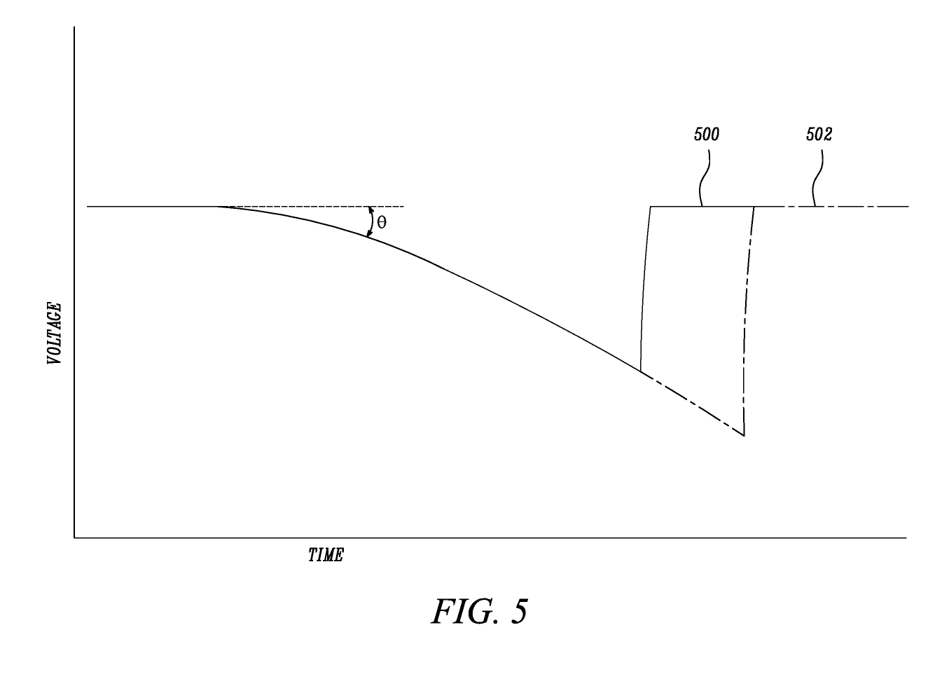

FIG. 5 illustrate example waveforms 500 and 502 of the secondary voltage with respect to time for different operating conditions at secondary side or different operating durations. The waveforms 500 and 502 may illustrate secondary voltage with respect to time during different months of the operation of the spark plug 150. For example, waveform 500 may illustrate secondary voltage of the spark plug 150 during a particular month and waveform 502 may illustrate secondary voltage of the spark plug 150 during a subsequent month. As shown in FIG. 5, slope of the waveforms 500 and 502 during the post breakdown phase is constant and denoted by tan(θ).

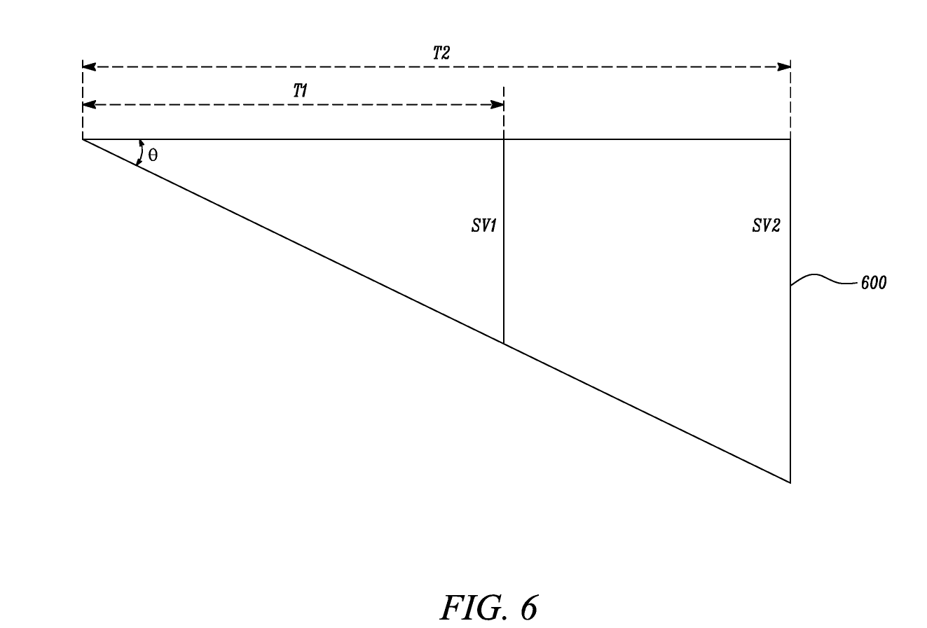

FIG. 6 is an example representation 600 of the secondary voltages and time durations of breakdown phase for the waveforms 500 and 502 shown in FIG. 5. Referring to FIG. 6, using the mathematical functions, it can be calculated that the ratio of secondary voltage and time duration of the breakdown phase is same for the waveforms 500 and 502.

$$tan ( θ ) = \frac{SV 1}{T 1} = \frac{SV 2}{T 2}$$

An initial value of secondary voltage (e.g. SV1) and corresponding time duration of breakdown phase (e.g. T1) may be computed from secondary voltage waveform. Using these values, tan(θ) can be computed. Now, for all different times of operation of the spark plug 150 and/or different operating conditions at the secondary side, the secondary voltage may be computed by multiplying the time duration of the breakdown phase with the computed value of tan(θ). Referring to FIG. 3, the rise time 308 is sum of the time 310 of breakdown phase and the time 312 of post breakdown phase. The time 310 representing breakdown phase can be computed by subtracting the time 312 representing post breakdown constant from the rise time 308. Thus, in other words, secondary voltage can be computed using the rise time 308.

Additionally, or alternatively, the detection module 156 may generate a signal indicative of a spark time i.e. time difference between closing of the high side switch 212 and the low side switch 216 and detection of the spark. The detection module 156 may be configured to provide the signal indicative of the spark time to the controller 158. Referring to FIG. 3, the spark time may be represented by time duration 310. The controller 158 may be configured to determine the secondary voltage using the spark time. In some embodiments, the ECU 154 may use a combination of spark time and rise time to determine secondary voltage, so as to enhance reliability of the detection module 156.

The controller 158 may be configured to determine the secondary voltage based on the determined spark time and/or rise time, such as by using one or more algorithms, equations, maps and/or look-up tables that define a relationship between secondary voltage and spark time and/or rise time. In certain embodiments, the secondary voltage may be used to determine condition of the spark plug 150. For example, the controller 158 may compare the secondary voltage to a threshold value. Based on the comparison, the controller 158 may determine the health state of the spark plug 150. The health state may be used to schedule diagnostics, generate recommendations and/or maintenance of the spark plug 150. In some embodiments, the controller 158 generates a notification corresponding to the health state of the spark plug 150. Using the techniques discussed above, the spark plug 150 can be diagnosed easily using the parameters associated with the primary side of the ignition coil 148, promoting efficient use of the spark plug 150 and reducing maintenance costs.

In some embodiments, the detection module 156 further allows for determining secondary voltage, even under adverse conditions, such as multi-arc conditions, low secondary voltage conditions, and high secondary voltage conditions. A multi-arc condition occurs when a spark plug produces multiple sparks (or arcs) during one ignition cycle. The detection module 156 may be configured to detect a multi-arc condition using one or more parameters associated with the current flowing through the primary coil 206. In some embodiments, the detection module 156 is configured to process the current flowing through the primary coil 206 and determine the time instants of all the sparks in case of multiple sparks. The presence of multiple sparks may sometime result in an error in the secondary voltage calculation as the detection module 158 may consider a second spark or a later spark for generating the signal indicative of the time duration. For proper calculation of secondary voltage, the detection module 156 may be configured to use the time duration associated with a first spark in case of multiple sparks. The detection module provides the signal indicative of the time duration to the controller 158. In adverse conditions, the controller 158 may be configured to determine the secondary voltage using the signal indicative of the time duration associated with the first spark. Thus, the ECU 154 may be configured to determine secondary voltage, even under a multi-arc condition.

### INDUSTRIAL APPLICABILITY

The present disclosure is related to a method and a system for determining health state of the spark plug 150. The exemplary disclosed detection module 156 may be applicable to any ignition system that includes a spark igniter, providing a more robust and consistent system for measuring one or more parameters associated with a spark plug and/or ignition coil (e.g., generation of a spark during an ignition cycle). In some embodiments, the detection module 156, is configured to measure rise time associated with the current flowing through the primary coil 206. Additionally, or alternatively, the detection module 156 is configured to measure spark time by detecting the time at which the spark occurs. For example, the controller 158 may use a combination of spark time and rise time to determine secondary voltage, such as to enhance reliability of the detection module 156. In this way, engine maintenance (e.g., spark plug replacement) may be carried out more efficiently.

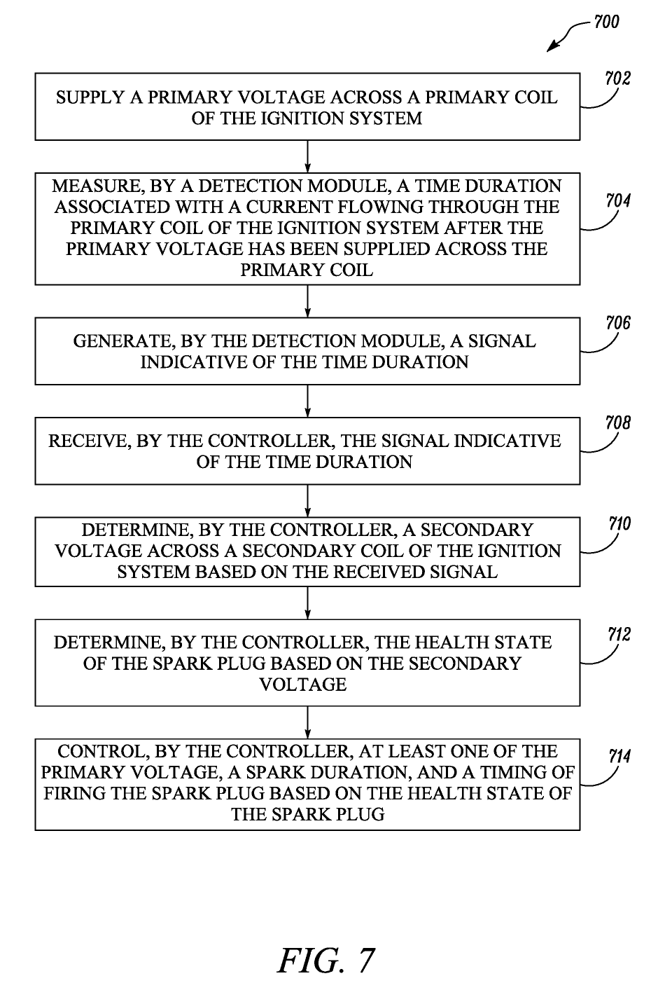

Referring to FIG. 7, a method 700 of determining health state of the spark plug 150 is illustrated. At step 702, the primary voltage is supplied across the primary coil 206 of the ignition system 146. The power source 152 is used to provide the primary voltage to the primary coil 206. The fuel mixture is ignited in the combustion chamber 110 by generating the spark through the spark plug 150. In other words, to initiate combustion of the fuel mixture during a startup event or during operation of the engine 100, the spark plug 150 generates a spark that locally heats the mixture, thereby creating a flame that propagates throughout the combustion chamber 110.

At step 704, the detection module 156 measures the time duration associated with the current flowing through the primary coil 206 of the ignition system 146 after the primary voltage has been supplied to the primary coil 206. In some embodiments, the time duration may be rise time of the current flowing through the primary coil 206. Additionally, or alternatively, the time duration may be the spark time. At step 706, the detection module 156 is configured to generate the signal indicative of the time duration. At step 708, the controller 158 receives the signal from the detection module 156 for further processing. At step 710, the controller 158 determines the secondary voltage across the secondary coil 218 of the ignition system 146. The controller 158 determines the secondary voltage based on the received signal indicating the time duration.

The secondary voltage is a good indication of the health state of the spark plug 150. Based on the determined secondary voltage, the controller 158 is configured to determine the health state of the spark plug 150 at step 712. For example, the health state may include a remaining life of the spark plug 150. The health state may also be used to schedule diagnostics and/or maintenance of the spark plug 150. At step 714, the controller 158 is configured to control at least one of the primary voltage, the spark duration and the timing of firing the spark plug 150 based on the health state of the spark plug 150. Additionally, or alternatively, the controller 158 generates a notification corresponding to the health state of the spark plug 150.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A method for determining a health state of a spark plug of an ignition system, the method comprising:
supplying a primary voltage across a primary coil of the ignition system;
measuring, by a detector, a time duration associated with a current flowing through the primary coil of the ignition system after the primary voltage has been supplied across the primary coil;
generating, by the detector, a signal indicative of the time duration;
receiving, by an electronic control unit, the signal indicative of the time duration;
determining, by the electronic control unit, a secondary voltage across a secondary coil of the ignition system based on the received signal;
determining, by the electronic control unit, the health state of the spark plug based on the secondary voltage; and
controlling, by the electronic control unit, at least one of:
the primary voltage supplied to the primary coil based on the health state of the spark plug;
a spark duration of the spark plug based on the health state of the spark plug, or
a timing of firing the spark plug based on the health state of the spark plug.

2. The method of claim 1, further including supplying a fuel mixture to a combustion chamber of an engine and igniting the fuel mixture in the combustion chamber by generating a spark through the spark plug.

3. The method of claim 1, wherein measuring the time duration includes measuring a rise time of the current flowing through the primary coil.

4. The method of claim 1, wherein measuring the time duration includes measuring a spark time based on the current flowing through the primary coil.

5. The method of claim 1, further including generating a notification corresponding to the health state of the spark plug.

6. The method of claim 1, further including comparing the secondary voltage to a threshold, and determining the health state of the spark plug based on the comparison.

7. The method of claim 1, wherein determining the health state of the spark plug includes determining a remaining life of the spark plug, and wherein controlling the at least one of the primary voltage, the spark duration, or the timing of firing the spark plug includes controlling the at least one of the primary voltage, the spark duration, or the timing of firing the spark plug based on the remaining life of the spark plug.

8. The method of claim 1, wherein determining the secondary voltage includes determining the secondary voltage in a multi-arc condition.

9. A system for determining a health state of a spark plug, the system comprising:
an ignition system including a primary coil, a secondary coil, and the spark plug;
a power supply coupled to the ignition system, the power supply configured to supply a primary voltage across the primary coil of the ignition system;
a detector coupled to the ignition system, the detector configured to measure a time duration associated with a current flowing through the primary coil of the ignition system after the primary voltage has been supplied across the primary coil, and generate a signal indicative of the time duration; and
an electronic control unit communicably coupled to the detector, the electronic control unit configured to:
receive the signal indicative of the time duration;
determine a secondary voltage across the secondary coil of the ignition system based on the received signal;
determine the health state of the spark plug based on the secondary voltage; and
control at least one of:
the primary voltage supplied to the primary coil based on the health state of the spark plug;
a spark duration of the spark plug based on the health state of the spark plug, or
a timing of firing the spark plug based on the health state of the spark plug.

10. The system of claim 9, wherein the detector is configured to measure the time duration associated with a rise time of the current flowing through the primary coil.

11. The system of claim 9, wherein the detector is configured to measure the time duration associated with a spark time based on the current flowing through the primary coil.

12. The system of claim 9, wherein the electronic control unit is further configured to generate a notification corresponding to the health state of the spark plug.

13. The system of claim 9, wherein the electronic control unit is further configured to compare the secondary voltage to a threshold, and determine the health state of the spark plug based on the comparison.

14. The system of claim 9, wherein the health state of the spark plug includes a remaining life of the spark plug and wherein the electronic control unit is configured to control at least one of the primary voltage, the spark duration, or the timing of firing the spark plug based on the remaining life of the spark plug.

15. The system of claim 9, wherein the electronic control unit is further configured to determine the secondary voltage in a multi-arc condition.

16. An engine comprising:
a combustion chamber;
an ignition system including a primary coil, a secondary coil, and a spark plug wherein the spark plug is configured to ignite a fuel mixture by generating a spark within the combustion chamber;
a power supply coupled to the ignition system, the power supply configured to supply a primary voltage across the primary coil of the ignition system;
a detector coupled to the ignition system, the detector configured to measure a time duration associated with a current flowing through the primary coil after the primary voltage has been supplied across the primary coil, and generate a signal indicative of the time duration; and
an electronic control unit communicably coupled to the detector, the electronic control unit configured to:
receive the signal indicative of the time duration;
determine a secondary voltage across the secondary coil based on the received signal;
determine a health state of the spark plug based on the secondary voltage; and
control at least one of:
the primary voltage supplied to the primary coil based on the health state of the spark plug;
a spark duration of the spark plug based on the health state of the spark plug, or
a timing of firing the spark plug based on the health state of the spark plug.

17. The engine of claim 16, wherein the detector is configured to measure the time duration associated with a rise time of the current flowing through the primary coil.

18. The engine of claim 16, wherein the detector is configured to measure the time duration associated with a spark time based on the current flowing through the primary coil.

19. The engine of claim 16, wherein the electronic control unit is further configured to generate a notification corresponding to the health state of the spark plug.

20. The engine of claim 16, wherein the electronic control unit is further configured to determine the secondary voltage in a multi-arc condition.
